(19) United States
(12) Patent Application Publication
(10) Pub. No.: US 2018/0004681 A1
(43) Pub. Date: Jan. 4, 2018

(54) Systems, Apparatuses, and Methods for Platform Security

(71) Applicant: Intel Corporation, Santa Clara, CA (US)

(72) Inventor: David A. Koufaty, Portland, OR (US)

(21) Appl. No.: 15/201,389

(22) Filed: Jul. 2, 2016

(51) Int. Cl. G06F 12/14; G06F 12/1027; G06F 12/10; G06F 12/1009

(52) U.S. Cl. CPC G06F 12/145; G06F 12/1009; G06F 12/1027; G06F 12/10; G06F 2212/1016; G06F 2212/651; G06F 2212/656; G06F 2212/657; G06F 2212/1052

(57) ABSTRACT

Systems, methods, and apparatuses for platform security are described. For example, in an embodiment, an apparatus includes address translation circuitry to translation a virtual address to a physical address and to provide a first protection domain, at least one protection range register, the at least one protection range register to store a range of virtual addresses to protect as part of a protection domain, and comparison circuitry to compare the virtual address to the range of virtual addresses of the at least one protection range register and to output a second protection domain upon a match in of the virtual address and the range of virtual addresses of the at least one protection register.

### FIELD OF INVENTION

The field of invention relates generally to computer processor architecture, and, more specifically, to platform security.

### BACKGROUND

In a multitenant architecture, multiple databases from different customers are hosted by a pool of threads. The threads serving a database are adapted dynamically in response to system demands. For performance reasons, the memory associated with all these databases may be mapped to the address space on all threads serving all databases. Achieving isolation between these instances is critical. Achieving this isolation using page protection is not practical, as it would require mapping and unmapping large portions of the address space dynamically, which is extremely expensive.

### BRIEF DESCRIPTION OF THE DRAWINGS

The present invention is illustrated by way of example and not limitation in the figures of the accompanying drawings, in which like references indicate similar elements and in which:

FIG. 1 illustrates an example of memory regions belonging to different customer databases;

FIG. 2 illustrates exemplary embodiments for a protection range register (PRR);

FIG. 3 illustrates an embodiment of a block diagram of portion hardware processor core;

FIG. 4 is a schematic illustration of an address translation scheme or mapping for accessing 4 or 64 Kbyte pages in a physical memory with linear address such as linear address according to an embodiment;

FIG. 5 illustrates an embodiment of a method;

FIG. 6 illustrates an embodiment of multitenant database using PRR to isolate the multiple databases;

FIG. 7 illustrates an embodiment of a method;

FIG. 8 is a block diagram of a register architecture according to one embodiment of the invention;

FIG. 9A is a block diagram illustrating both an exemplary in-order pipeline and an exemplary register renaming, out-of-order issue/execution pipeline according to embodiments of the invention;

FIG. 9B is a block diagram illustrating both an exemplary embodiment of an in-order architecture core and an exemplary register renaming, out-of-order issue/execution architecture core to be included in a processor according to embodiments of the invention;

FIGS. 10A-B illustrate a block diagram of a more specific exemplary in-order core architecture, which core would be one of several logic blocks (including other cores of the same type and/or different types) in a chip;

FIG. 11 is a block diagram of a processor 1100 that may have more than one core, may have an integrated memory controller, and may have integrated graphics according to embodiments of the invention;

FIGS. 12-15 are block diagrams of exemplary computer architectures;

FIG. 16 is a block diagram contrasting the use of a software instruction converter to convert binary instructions in a source instruction set to binary instructions in a target instruction set according to embodiments of the invention; and

FIG. 17 illustrates an embodiment of fields of a PTE.

### DETAILED DESCRIPTION

In the following description, numerous specific details are set forth. However, it is understood that embodiments of the invention may be practiced without these specific details. In other instances, well-known circuits, structures and techniques have not been shown in detail in order not to obscure the understanding of this description.

References in the specification to “one embodiment,” “an embodiment,” “an example embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

A multitenant database architecture requires a very large amount of memory and use thousands of threads. For performance reasons, these threads share a common address space: all the memory is mapped into every single thread. The memory may be divided into several regions, for example, memory that is shared between all threads, memory that is private to a thread, and memory that is associated with a particular database.

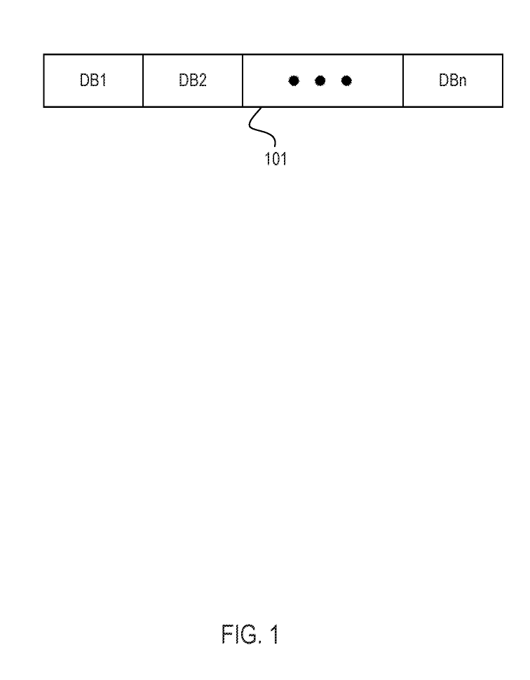

FIG. 1 illustrates an example of memory regions belonging to different customer databases 101. One memory region is assigned to database 1 (DB1), a second region is assigned to a database 2 (DB2), and so on. Isolation is a reliability requirement as a thread operating on database 1 should not have the capability to access data on database 2 through n.

Typical paging architectures provide isolation via permission bits for each page like read, write and execution permissions. Operating systems change the permissions of a page by editing these bits, an operation that is typically very expensive due to the need to keep all processors' translation lookaside buffers (TLBs) synchronized. Providing isolation in a multitenant architecture (such as that of FIG. 1) requires extensive page mapping and unmapping, which is very expensive.

Some protection key architectures use a paging structure to tag memory with a protection domain, which effectively guarantees that all threads using the same paging structure will see the same protection domain for a given address. Protection keys tag each memory page with an n-bit protection domain. Additional permissions are associated with each protection domain, typically in a CPU register, which allows software to quickly change the permissions of all the pages that are tagged with the same protection domain. In some embodiments, bits (e.g., 4 bits such as 62:59 allowing for 16 protection domains) of a paging-structure entry that mapped the page containing the linear address store a protection key (protection domain). For example, four bits of a page table entry. A register setting determines, for each protection key, whether user-mode addresses with that protection key may be read or written.

In a multitenant database, isolation can be achieved by tagging the pages associated with each database tenant with a unique protection domain and changing the permissions of the protection domains a thread can access to allow access only to one database at a time, which is a very inexpensive operation. Unfortunately, the number of protection domains supported in hardware is limited by the number of available bits in the paging structures, which is usually very small (e.g., 4 bits as detailed above), limiting this approach to a very small number of database tenants.

A thread only serves queries to one database at a time. Over time, threads assigned to a database change in response to the system demands. As demands change, hardware that supports thread isolation should adapt according to the thread's assigned database. When a thread switches from serving one database to another, permissions to the database instance memory need to be updated.

One way to accomplish this memory protection requirement is to change the paging permissions of the memory in DB1-DBn when the switch occurs, but this requires extensive editing of paging structures (mapping terabytes of data) and would significantly impact performance. A second mechanism is to tag each memory sub-region (e.g., DB 1, DB 2, . . . DB n) with unique protection domains and when the switch occurs, change the permissions of all domains to allow memory operations only on the domain that the thread is serving (e.g., domain 3 is read/write, others are no access). This works as long as n is less or equal to the number of protection domains available in hardware. Unfortunately, trends suggest that a single system may be serving hundreds, if not thousands, of database instances, which renders this approach impractical.

Detailed herein are embodiments of tagging memory with a protection domain using one or more protection range registers. Each of the protection range registers identifies two things: a memory range (for example, a base address and a limit address) and the protection domain for the range. Since these registers reside on a processor (e.g., a central processing unit (CPU) or core thereof), each thread can have a different view of the protection domain that a page belongs to. The number of protection range registers is implementation dependent.

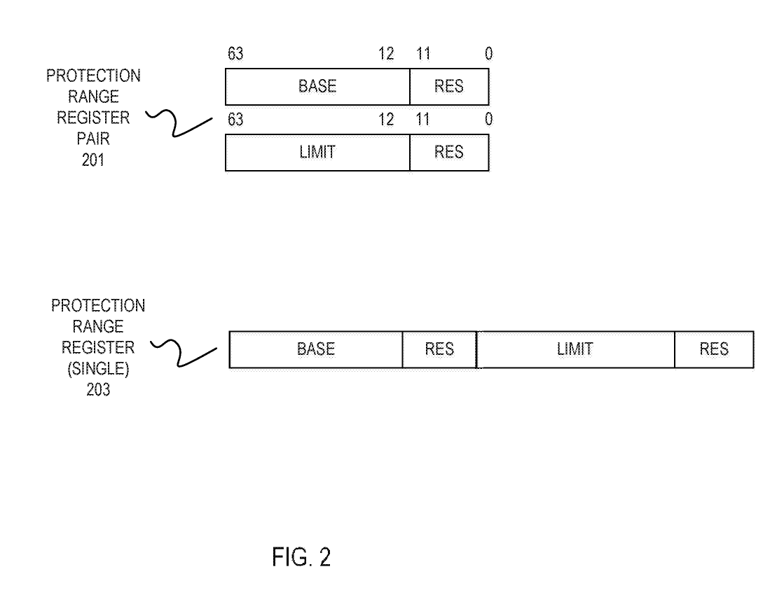

FIG. 2 illustrates exemplary embodiments for a protection range register (PRR). A PRR consists of at least two parts: a memory range, which is a range in the processor virtual (linear) address space to protect as a part of a protection domain, and a protection domain. The memory range may be specified in a number of ways. For example, the range may be specified by a base virtual address and a limit virtual address as illustrated, but any way to connote a range is acceptable. In some embodiments, a protection range register is implemented as a pair of registers 201. As shown, the components of the virtual address range (base and limit) are stored in separate registers. Some bits are reserved (shown as RES) additional, non-address information such as bits for a protection domain (e.g., 4 bits) and a valid bit (the PRR is enabled) or a combination of base/limit (e.g. base=limit=0) to specify when the range is in effect. Typically, a reserved section only stores one piece of additional information (for example, a reserve section of the “base” register would only store a protection domain and the “limit” register would store the valid bit). However, a single reserved section houses all of the additional information in some embodiments. Note that in some embodiments, this additional information is stored in a different register altogether, but that is associated with the pair. In some embodiments, a PRR is a single register 203. The same information is stored in the single register 203 as the pair 201.

When using protection range registers, a protection domain lookup is as follows: when the virtual address of the memory operation matches a PRR (it is found within the specified range of the PRR), the protection domain associated with the virtual address is obtained from the PRR, ignoring the protection domain from the page table used to calculated the associated physical address. When the virtual address does not match a PRR, the protection domain is obtained from the page tables. An example of pseudo-code to obtain protection domain for an address as shown below where PTE refers to the leaf node of the paging structure that contains the protection domain for the address.

function domain(address)
if (prr.base<=address<prr.limit) return prr.protection domain;
   else
return PTE(address).protection domain

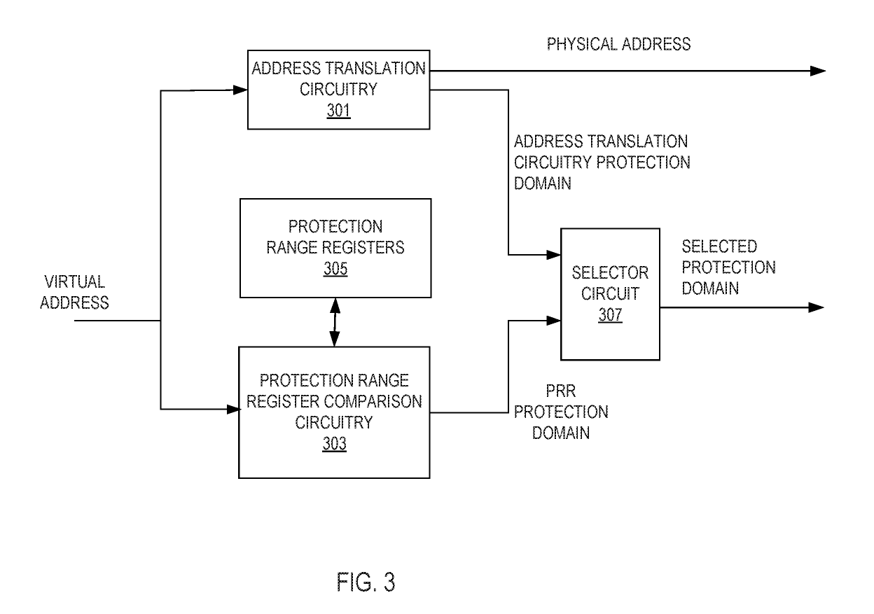

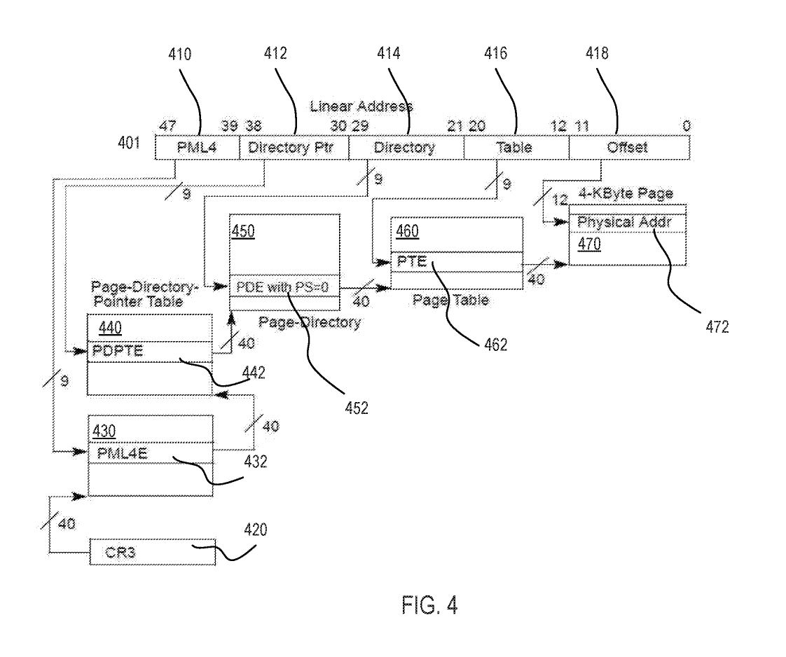

FIG. 3 illustrates an embodiment of a block diagram of portion hardware processor core. In this illustration, many components are not illustrated for the sake of ease of understanding. As shown, a virtual (linear) address is input into address translation circuitry 301 (such as a translation lookaside buffer (TLB)) and protection range register comparison circuitry 303. The address translation circuitry 301 maps the virtual address to a physical address and outputs a protection domain (referred to as address circuitry protection domain in the figure. FIG. 4 is a schematic illustration of an address translation scheme or mapping for accessing 4 pages in a physical memory with linear address such as linear address 401 according to an embodiment. The address translation scheme of FIG. 4 for a linear address 401 may have a configuration in which four kinds of tables or paging structures—page map level (PML) 4 table 430, page directory pointer (PDP) table 440, page directory 450, and page table 460—are connected by pointers or links. The hierarchy of these tables may be structured with PML 4 table 430 at the highest level, followed by PDP table 440, page directory 450, and page table 460 at the lowest level. For the embodiments of FIG. 4, at least some portion of memory may be divided into 4 or 64 Kbyte pages, although other fixed page sizes may be used and other numbers of page sizes may be used. Further, in the embodiment of FIG. 4, all paging structures may include 512 entries having a length of 8 bytes, e.g. each entry is 64 bits. Such 64 bit entries may be used by for example a computing system implementing an Intel IA-32e processor architecture.

In one embodiment linear address 401 may include five sets of bits: PML 4 table bits 410, PDP table bits 412, page directory bits 414, page table bits 416, and offset bits 418. Each of these sets of bits may provide an offset used in translating linear address 401 to a corresponding physical address. Other bit mapping hierarchies may also be used, and other sets of bits may be used.

A control register 420 or another memory space may store or contain the physical address of PML 4 table 420. An entry in PML 4 table 430 such as PML 4 entry 432 may be selected or determined by for example bits 47:39, e.g. PML 4 table bits 410 of linear address 401. PML 4 entry 432 may be used for all linear addresses in the 512-Gbyte region of linear addresses with the same value in bits 47:39. Here and elsewhere herein, other specific locations may be used.

The bits of PML 4 entry 432 may be used as an offset from the base address of PML 4 table 430 to access PDP table 440. Specifically, PML 4 entry 432 may contain the physical address of PDP table 440. A PDP table entry 442 may be selected or determined by for example bits 38:30 of linear address 401, e.g. PDP table bits 412. PDP table entry 442 may be used for all linear addresses in the 1-Gbyte region of linear addresses with the same value in bits 47:30.

The bits or information of PDP table entry 442 may be used to access page directory 450. For example, PDP table entry 442 may contain the physical address of page directory 450. A page directory entry (PDE) 452 may be selected or determined by for example bits 29:21 of linear address 401, e.g. page directory bits 414. PDE 452 may be used for all linear addresses in the 2-Mbyte region of linear addresses with the same value in bits 47:21.

The bits of PDE 452 may be used to access page table 460. For example, PDE 452 may contain the physical address of page table 460. A page table entry 462 may be selected or determined by for example bits 20:12 of linear address 401, e.g. page table bits 416. Page table entry 462 may be used for all linear addresses in the 4-Kbyte region of linear addresses with the same value in bits 47:12.

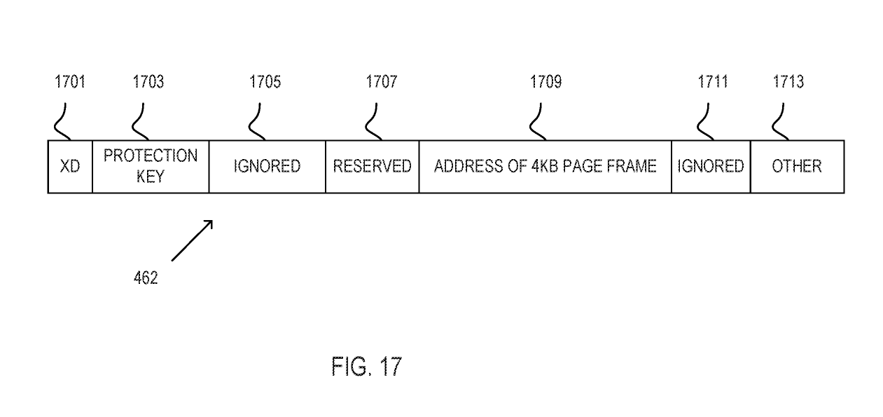

The bits of page table entry 462 may be used to access a page 470. For example, page table entry 462 may contain the physical address of page 470. A physical address 472 may be selected or determined by bits for example 11:0 of linear address 401, e.g. page table bits 418. Additionally, a page table entry (PTE) includes a protection domain in some embodiments. FIG. 17 illustrates an embodiment of fields of a PTE 462. An XD bit field 1701 is used to indicate execute-disable. The protection domain field is shown in 1703. In some embodiments, several fields are ignored (1705 and 1711) or reserved 1707. A physical address of a 4-byte page field 1709 is provided. Finally, other fields 1713 provide for read/write, user-mode access, page-level write-through, page-level cache disable, access, dirty, memory type, and global translation indications.

The protection range register comparison circuitry 303 access protection range registers 305 to look for a match. A virtual address matches the PRR if it within the range (e.g., it is base<=address<limit). When there is a match, the protection range register comparison circuitry outputs the protection domain from the matching PRR (shown as PRR protection domain). A selector circuit 307 (e.g., a mux) outputs a selected protection domain (e.g., it outputs the address translation circuitry when there is no PRR match, or the PRR protection domain when there is a PRR match).

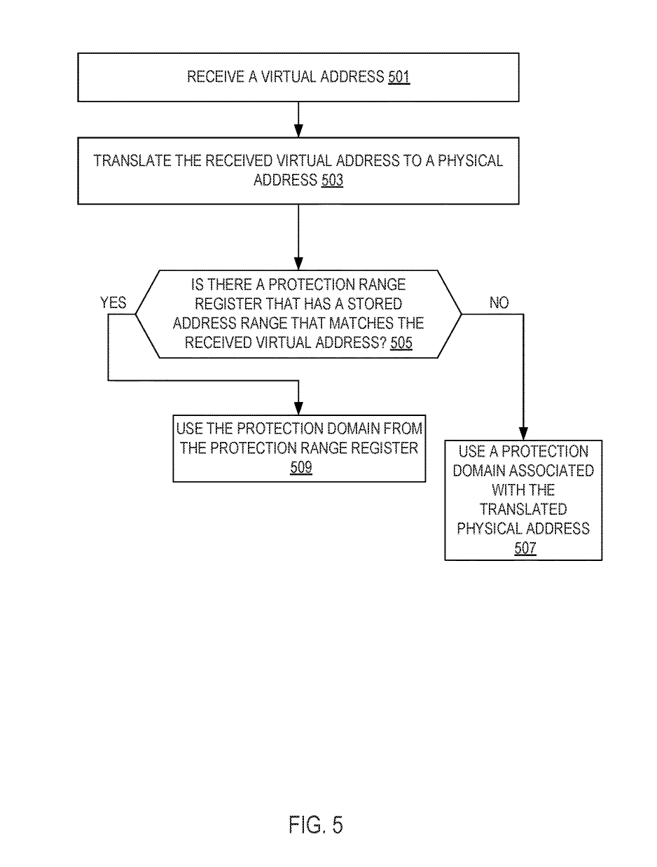

FIG. 5 illustrates an embodiment of a method. Typically, this method is performed within a hardware processor using components such as those detailed in FIG. 3. At 501, a virtual address is received. For example, the virtual address is received by address translation circuitry 301 and protection range register comparison circuitry 303.

The received virtual address is translated at 503. For example, the received virtual address is translated by address translation circuitry 301. The translation results in a physical address and associated protection domain.

A determination of if there is a protection range register that has a stored address range that matches the received virtual address is made at 505. For example, the protection range register comparison circuitry 303 compares the received virtual address to the base and limit addresses stored by PRRs 305.

When there is no match, the protection domain associated with the translated physical address is used at 507. For example, the domain output from the address translation circuitry 301.

When there is a match, the protection domain associated with the matching PRR is used at 507. For example, the domain output from the protection range register comparison circuitry 303.

Not shown in the figure is the application of the protection domain to restrict access.

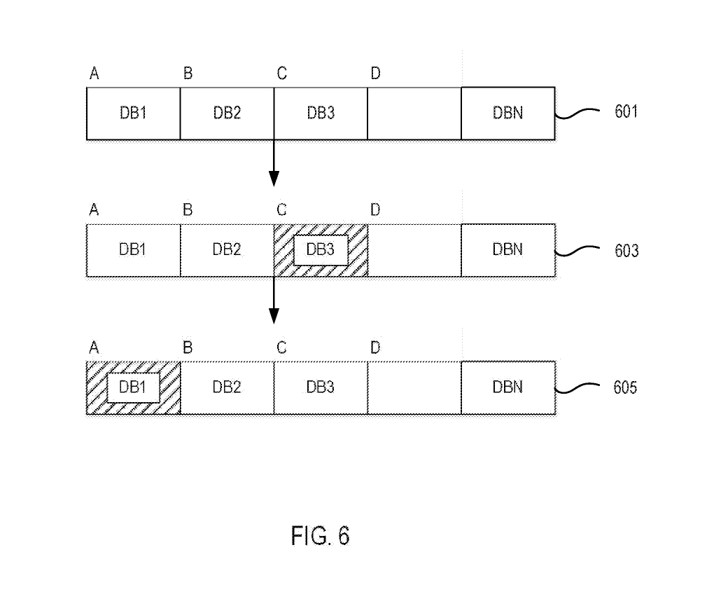

FIG. 6 illustrates an embodiment of multitenant database using PRR to isolate the multiple databases. DB 1, DB 2, . . . , DB refer to the private memory of multiple database instances in a multitenant architecture.

In this example, only two protection domains are needed shown as shaded or not shaded (these could be any two domains supported by the hardware, say domains 2 and 9). The permissions for these domains are fixed at run time with domain not shaded permissions are set to no access, while domain shaded permissions are set to read/write (R/W). The page tables comprising all the memory regions belonging to all the tenant databases to be isolated is labeled as domain not shaded. While this memory is shown as contiguous for simplicity, it does not need to be, as the tagging with domain not shaded is done in the page tables. Giving this configuration, a thread does not have access to any location in the not shaded region as shown in 601.

When a thread needs to start servicing requests from DB 3, one change is made as shown in 603, with the PRR associated with that thread set to point to DB 3 memory range (C base-D limit in the example) and domain shaded. At this point, the thread is granted access to region C-D because domain shaded is R/W. Notice that since PRR resides on the CPU, threads running on other CPUs observe the permissions set in their own PRR, and are not affected by this CPU's PRR.

When the thread needs to stop servicing DB 3 and start servicing DB 1, a change to the PRR is required as shown in 605) with the base and limit address set to A base-B limit and the domain remains shaded. After this change, the thread has lost the ability to access DB 3 and can only access DB 1.

For security reasons, it is likely that the PRR can only be set by the operating system, in that case a system call is required from the application to change it. When the operating systems context switches a thread, it would be required to save/restore the PRR just like any other architectural register.

In some embodiments of the protection key architecture, the processor's TLB may cache the protection domain associated with a virtual address. When the architecture supports PRR, the processor's TLB may instead cache the “combined” protection domain (e.g., the selected protection domain of FIG. 3). In this case, a flush of the local TLB is needed after a PRR change to account for the selected protection domain.

In the example above, the memory associated with each database instance has to be contiguous because the PRR can only specify one contiguous virtual memory range. This may be acceptable for many usages, but if not, multiple PRRs may be supported by the architecture. In that case, some prioritization in the case of overlapping ranges is defined by the architecture, for example, the first match is reported.

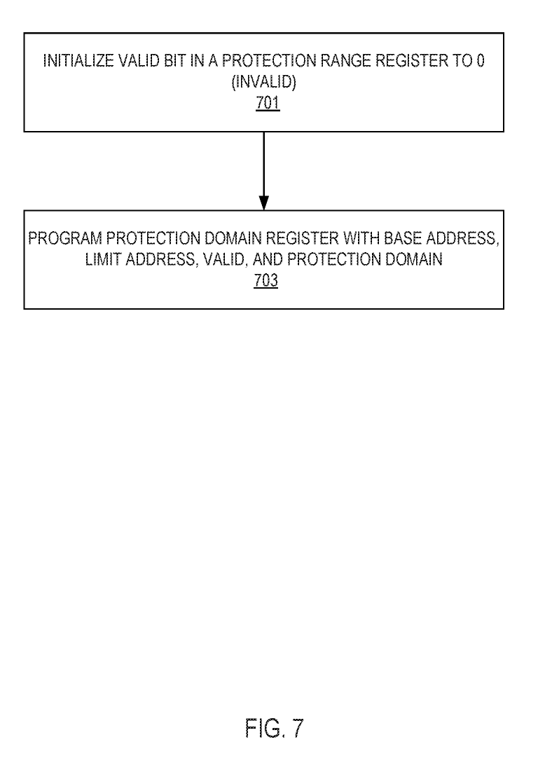

FIG. 7 illustrates an embodiment of a method. This method is typically performed by an operating system, however, one or more may be done by hardware automatically.

At 701, valid bits in the protection range registers set to 0 (invalid). While this may be set by the OS, when initialized for this first time this may be done by hardware automatically.

At some point later in time, a protection range register needs to be set. At 703, a protection range register is programmed with a base address, limit address, set to valid, and a protection domain selected.

The figures below detail exemplary architectures and systems to implement embodiments of the above. In some embodiments, one or more hardware components and/or instructions described above are emulated as detailed below, or implemented as software modules.

### Exemplary Register Architecture

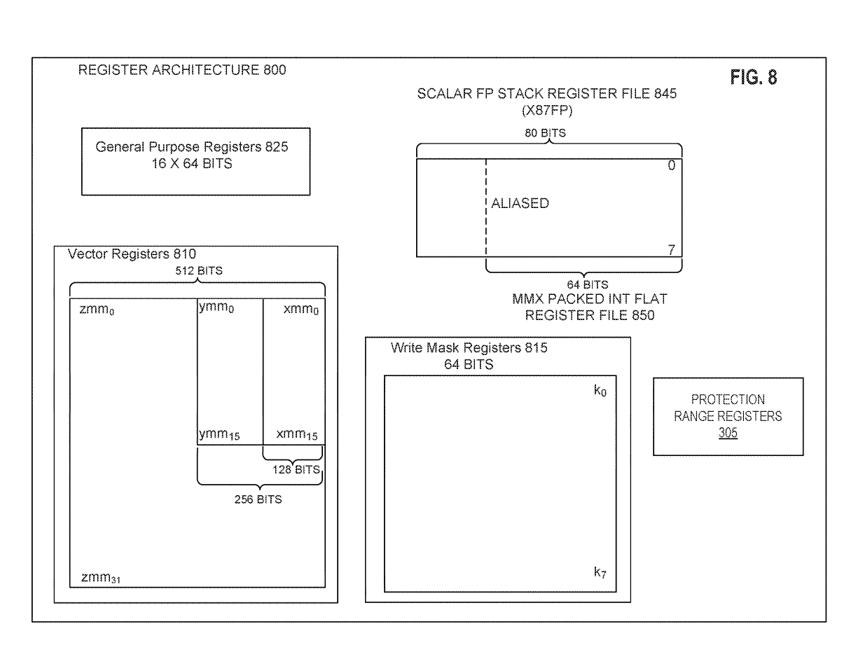

FIG. 8 is a block diagram of a register architecture 800 according to one embodiment of the invention. In the embodiment illustrated, there are 32 vector registers 810 that are 512 bits wide; these registers are referenced as zmm0 through zmm31. The lower order 256 bits of the lower 16 zmm registers are overlaid on registers ymm0-16. The lower order 128 bits of the lower 16 zmm registers (the lower order 128 bits of the ymm registers) are overlaid on registers xmm0-15.

Write mask registers 815—in the embodiment illustrated, there are 8 write mask registers (k0 through k7), each 64 bits in size. In an alternate embodiment, the write mask registers 815 are 16 bits in size. As previously described, in one embodiment of the invention, the vector mask register k0 cannot be used as a write mask; when the encoding that would normally indicate k0 is used for a write mask, it selects a hardwired write mask of 0xFFFF, effectively disabling write masking for that instruction.

General-purpose registers 825—in the embodiment illustrated, there are sixteen 64-bit general-purpose registers that are used along with the existing x86 addressing modes to address memory operands. These registers are referenced by the names RAX, RBX, RCX, RDX, RBP, RSI, RDI, RSP, and R8 through R15.

Scalar floating point stack register file (x87 stack) 845, on which is aliased the MMX packed integer flat register file 850—in the embodiment illustrated, the x87 stack is an eight-element stack used to perform scalar floating-point operations on 32/64/80-bit floating point data using the x87 instruction set extension; while the MMX registers are used to perform operations on 64-bit packed integer data, as well as to hold operands for some operations performed between the MMX and XMM registers.

PRR 305 has already been described.

Alternative embodiments of the invention may use wider or narrower registers. Additionally, alternative embodiments of the invention may use more, less, or different register files and registers.

### Exemplary Core Architectures, Processors, and Computer Architectures

Processor cores may be implemented in different ways, for different purposes, and in different processors. For instance, implementations of such cores may include: 1) a general purpose in-order core intended for general-purpose computing; 2) a high performance general purpose out-of-order core intended for general-purpose computing; 3) a special purpose core intended primarily for graphics and/or scientific (throughput) computing. Implementations of different processors may include: 1) a CPU including one or more general purpose in-order cores intended for general-purpose computing and/or one or more general purpose out-of-order cores intended for general-purpose computing; and 2) a coprocessor including one or more special purpose cores intended primarily for graphics and/or scientific (throughput). Such different processors lead to different computer system architectures, which may include: 1) the coprocessor on a separate chip from the CPU; 2) the coprocessor on a separate die in the same package as a CPU; 3) the coprocessor on the same die as a CPU (in which case, such a coprocessor is sometimes referred to as special purpose logic, such as integrated graphics and/or scientific (throughput) logic, or as special purpose cores); and 4) a system on a chip that may include on the same die the described CPU (sometimes referred to as the application core(s) or application processor(s)), the above described coprocessor, and additional functionality. Exemplary core architectures are described next, followed by descriptions of exemplary processors and computer architectures.

### Exemplary Core Architectures

### In-Order and Out-of-Order Core Block Diagram

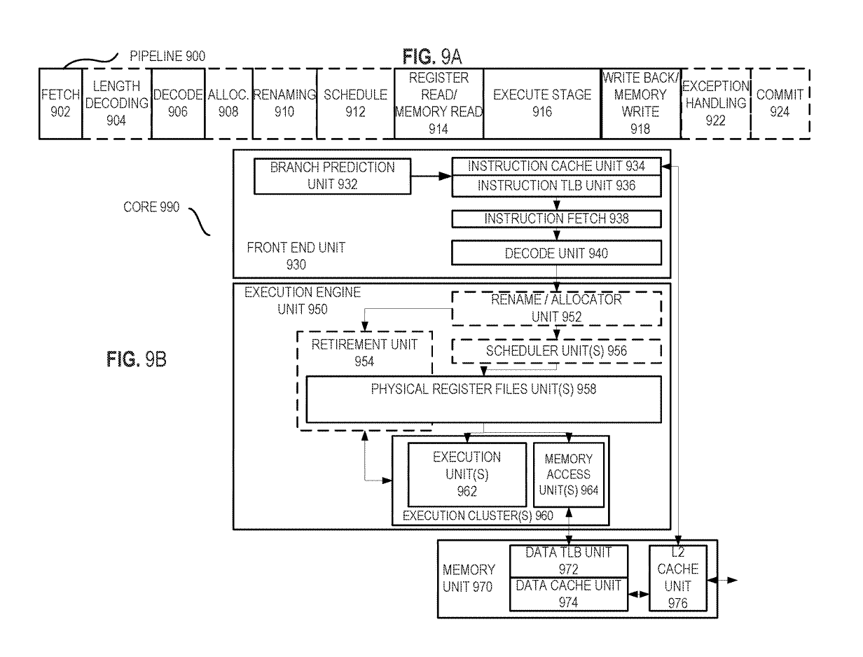

FIG. 9A is a block diagram illustrating both an exemplary in-order pipeline and an exemplary register renaming, out-of-order issue/execution pipeline according to embodiments of the invention. FIG. 9B is a block diagram illustrating both an exemplary embodiment of an in-order architecture core and an exemplary register renaming, out-of-order issue/execution architecture core to be included in a processor according to embodiments of the invention. The solid lined boxes in FIGS. 9A-B illustrate the in-order pipeline and in-order core, while the optional addition of the dashed lined boxes illustrates the register renaming, out-of-order issue/execution pipeline and core. Given that the in-order aspect is a subset of the out-of-order aspect, the out-of-order aspect will be described.

In FIG. 9A, a processor pipeline 900 includes a fetch stage 902, a length decode stage 904, a decode stage 906, an allocation stage 908, a renaming stage 910, a scheduling (also known as a dispatch or issue) stage 912, a register read/memory read stage 914, an execute stage 916, a write back/memory write stage 918, an exception handling stage 922, and a commit stage 924.

FIG. 9B shows processor core 990 including a front end unit 930 coupled to an execution engine unit 950, and both are coupled to a memory unit 970. The core 990 may be a reduced instruction set computing (RISC) core, a complex instruction set computing (CISC) core, a very long instruction word (VLIW) core, or a hybrid or alternative core type. As yet another option, the core 990 may be a special-purpose core, such as, for example, a network or communication core, compression engine, coprocessor core, general purpose computing graphics processing unit (GPGPU) core, graphics core, or the like.

The front end unit 930 includes a branch prediction unit 932 coupled to an instruction cache unit 934, which is coupled to an instruction translation lookaside buffer (TLB) 936, which is coupled to an instruction fetch unit 938, which is coupled to a decode unit 940. The decode unit 940 (or decoder) may decode instructions, and generate as an output one or more micro-operations, micro-code entry points, microinstructions, other instructions, or other control signals, which are decoded from, or which otherwise reflect, or are derived from, the original instructions. The decode unit 940 may be implemented using various different mechanisms. Examples of suitable mechanisms include, but are not limited to, look-up tables, hardware implementations, programmable logic arrays (PLAs), microcode read only memories (ROMs), etc. In one embodiment, the core 990 includes a microcode ROM or other medium that stores microcode for certain macroinstructions (e.g., in decode unit 940 or otherwise within the front end unit 930). The decode unit 940 is coupled to a rename/allocator unit 952 in the execution engine unit 950.

The execution engine unit 950 includes the rename/allocator unit 952 coupled to a retirement unit 954 and a set of one or more scheduler unit(s) 956. The scheduler unit(s) 956 represents any number of different schedulers, including reservations stations, central instruction window, etc. The scheduler unit(s) 956 is coupled to the physical register file(s) unit(s) 958. Each of the physical register file(s) units 958 represents one or more physical register files, different ones of which store one or more different data types, such as scalar integer, scalar floating point, packed integer, packed floating point, vector integer, vector floating point, status (e.g., an instruction pointer that is the address of the next instruction to be executed), etc. In one embodiment, the physical register file(s) unit 958 comprises a vector registers unit, a write mask registers unit, and a scalar registers unit. These register units may provide architectural vector registers, vector mask registers, and general purpose registers. The physical register file(s) unit(s) 958 is overlapped by the retirement unit 954 to illustrate various ways in which register renaming and out-of-order execution may be implemented (e.g., using a reorder buffer(s) and a retirement register file(s); using a future file(s), a history buffer(s), and a retirement register file(s); using a register maps and a pool of registers; etc.). The retirement unit 954 and the physical register file(s) unit(s) 958 are coupled to the execution cluster(s) 960. The execution cluster(s) 960 includes a set of one or more execution units 962 and a set of one or more memory access units 964. The execution units 962 may perform various operations (e.g., shifts, addition, subtraction, multiplication) and on various types of data (e.g., scalar floating point, packed integer, packed floating point, vector integer, vector floating point). While some embodiments may include a number of execution units dedicated to specific functions or sets of functions, other embodiments may include only one execution unit or multiple execution units that all perform all functions. The scheduler unit(s) 956, physical register file(s) unit(s) 958, and execution cluster(s) 960 are shown as being possibly plural because certain embodiments create separate pipelines for certain types of data/operations (e.g., a scalar integer pipeline, a scalar floating point/packed integer/packed floating point/vector integer/vector floating point pipeline, and/or a memory access pipeline that each have their own scheduler unit, physical register file(s) unit, and/or execution cluster—and in the case of a separate memory access pipeline, certain embodiments are implemented in which only the execution cluster of this pipeline has the memory access unit(s) 964). It should also be understood that where separate pipelines are used, one or more of these pipelines may be out-of-order issue/execution and the rest in-order.

The set of memory access units 964 is coupled to the memory unit 970, which includes a data TLB unit 972 coupled to a data cache unit 974 coupled to a level 2 (L2) cache unit 976. In one exemplary embodiment, the memory access units 964 may include a load unit, a store address unit, and a store data unit, each of which is coupled to the data TLB unit 972 in the memory unit 970. The instruction cache unit 934 is further coupled to a level 2 (L2) cache unit 976 in the memory unit 970. The L2 cache unit 976 is coupled to one or more other levels of cache and eventually to a main memory.

By way of example, the exemplary register renaming, out-of-order issue/execution core architecture may implement the pipeline 900 as follows: 1) the instruction fetch 938 performs the fetch and length decoding stages 902 and 904; 2) the decode unit 940 performs the decode stage 906; 3) the rename/allocator unit 952 performs the allocation stage 908 and renaming stage 910; 4) the scheduler unit(s) 956 performs the schedule stage 912; 5) the physical register file(s) unit(s) 958 and the memory unit 970 perform the register read/memory read stage 914; the execution cluster 960 perform the execute stage 916; 6) the memory unit 970 and the physical register file(s) unit(s) 958 perform the write back/memory write stage 918; 7) various units may be involved in the exception handling stage 922; and 8) the retirement unit 954 and the physical register file(s) unit(s) 958 perform the commit stage 924.

The core 990 may support one or more instructions sets (e.g., the x86 instruction set (with some extensions that have been added with newer versions); the MIPS instruction set of MIPS Technologies of Sunnyvale, Calif.; the ARM instruction set (with optional additional extensions such as NEON) of ARM Holdings of Sunnyvale, Calif.), including the instruction(s) described herein. In one embodiment, the core 990 includes logic to support a packed data instruction set extension (e.g., AVX1, AVX2), thereby allowing the operations used by many multimedia applications to be performed using packed data.

It should be understood that the core may support multithreading (executing two or more parallel sets of operations or threads), and may do so in a variety of ways including time sliced multithreading, simultaneous multithreading (where a single physical core provides a logical core for each of the threads that physical core is simultaneously multithreading), or a combination thereof (e.g., time sliced fetching and decoding and simultaneous multithreading thereafter such as in the Intel® Hyperthreading technology).

While register renaming is described in the context of out-of-order execution, it should be understood that register renaming may be used in an in-order architecture. While the illustrated embodiment of the processor also includes separate instruction and data cache units 934/974 and a shared L2 cache unit 976, alternative embodiments may have a single internal cache for both instructions and data, such as, for example, a Level 1 (L1) internal cache, or multiple levels of internal cache. In some embodiments, the system may include a combination of an internal cache and an external cache that is external to the core and/or the processor. Alternatively, all of the cache may be external to the core and/or the processor.

Specific Exemplary in-Order Core Architecture

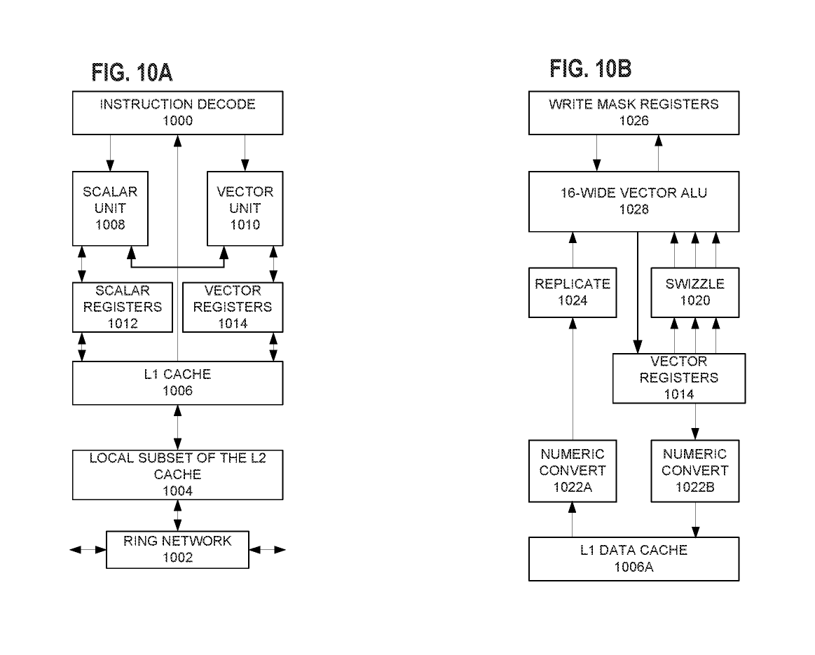

FIGS. 10A-B illustrate a block diagram of a more specific exemplary in-order core architecture, which core would be one of several logic blocks (including other cores of the same type and/or different types) in a chip. The logic blocks communicate through a high-bandwidth interconnect network (e.g., a ring network) with some fixed function logic, memory I/O interfaces, and other necessary I/O logic, depending on the application.

FIG. 10A is a block diagram of a single processor core, along with its connection to the on-die interconnect network 1002 and with its local subset of the Level 2 (L2) cache 1004, according to embodiments of the invention. In one embodiment, an instruction decoder 1000 supports the x86 instruction set with a packed data instruction set extension. An L1 cache 1006 allows low-latency accesses to cache memory into the scalar and vector units. While in one embodiment (to simplify the design), a scalar unit 1008 and a vector unit 1010 use separate register sets (respectively, scalar registers 1012 and vector registers 1014) and data transferred between them is written to memory and then read back in from a level 1 (L1) cache 1006, alternative embodiments of the invention may use a different approach (e.g., use a single register set or include a communication path that allow data to be transferred between the two register files without being written and read back).

The local subset of the L2 cache 1004 is part of a global L2 cache that is divided into separate local subsets, one per processor core. Each processor core has a direct access path to its own local subset of the L2 cache 1004. Data read by a processor core is stored in its L2 cache subset 1004 and can be accessed quickly, in parallel with other processor cores accessing their own local L2 cache subsets. Data written by a processor core is stored in its own L2 cache subset 1004 and is flushed from other subsets, if necessary. The ring network ensures coherency for shared data. The ring network is bi-directional to allow agents such as processor cores, L2 caches and other logic blocks to communicate with each other within the chip. Each ring data-path is 1012-bits wide per direction.

FIG. 10B is an expanded view of part of the processor core in FIG. 10A according to embodiments of the invention. FIG. 10B includes an L1 data cache 1006A part of the L1 cache 1004, as well as more detail regarding the vector unit 1010 and the vector registers 1014. Specifically, the vector unit 1010 is a 16-wide vector processing unit (VPU) (see the 16-wide ALU 1028), which executes one or more of integer, single-precision float, and double-precision float instructions. The VPU supports swizzling the register inputs with swizzle unit 1020, numeric conversion with numeric convert units 1022A-B, and replication with replication unit 1024 on the memory input. Write mask registers 1026 allow predicating resulting vector writes.

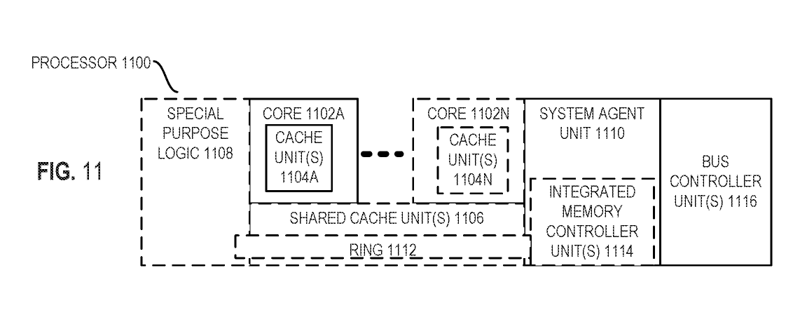

FIG. 11 is a block diagram of a processor 1100 that may have more than one core, may have an integrated memory controller, and may have integrated graphics according to embodiments of the invention. The solid lined boxes in FIG. 11 illustrate a processor 1100 with a single core 1102A, a system agent 1110, a set of one or more bus controller units 1116, while the optional addition of the dashed lined boxes illustrates an alternative processor 1100 with multiple cores 1102A-N, a set of one or more integrated memory controller unit(s) 1114 in the system agent unit 1110, and special purpose logic 1108.

Thus, different implementations of the processor 1100 may include: 1) a CPU with the special purpose logic 1108 being integrated graphics and/or scientific (throughput) logic (which may include one or more cores), and the cores 1102A-N being one or more general purpose cores (e.g., general purpose in-order cores, general purpose out-of-order cores, a combination of the two); 2) a coprocessor with the cores 1102A-N being a large number of special purpose cores intended primarily for graphics and/or scientific (throughput); and 3) a coprocessor with the cores 1102A-N being a large number of general purpose in-order cores. Thus, the processor 1100 may be a general-purpose processor, coprocessor or special-purpose processor, such as, for example, a network or communication processor, compression engine, graphics processor, GPGPU (general purpose graphics processing unit), a high-throughput many integrated core (MIC) coprocessor (including 30 or more cores), embedded processor, or the like. The processor may be implemented on one or more chips. The processor 1100 may be a part of and/or may be implemented on one or more substrates using any of a number of process technologies, such as, for example, BiCMOS, CMOS, or NMOS.

The memory hierarchy includes one or more levels of cache 1104A-N within the cores, a set or one or more shared cache units 1106, and external memory (not shown) coupled to the set of integrated memory controller units 1114. The set of shared cache units 1106 may include one or more mid-level caches, such as level 2 (L2), level 3 (L3), level 4 (L4), or other levels of cache, a last level cache (LLC), and/or combinations thereof. While in one embodiment a ring based interconnect unit 1112 interconnects the integrated graphics logic 1108, the set of shared cache units 1106, and the system agent unit 1110/integrated memory controller unit(s) 1114, alternative embodiments may use any number of well-known techniques for interconnecting such units. In one embodiment, coherency is maintained between one or more cache units 1106 and cores 1102-A-N.

In some embodiments, one or more of the cores 1102A-N are capable of multi-threading. The system agent 1110 includes those components coordinating and operating cores 1102A-N. The system agent unit 1110 may include for example a power control unit (PCU) and a display unit. The PCU may be or include logic and components needed for regulating the power state of the cores 1102A-N and the integrated graphics logic 1108. The display unit is for driving one or more externally connected displays.

The cores 1102A-N may be homogenous or heterogeneous in terms of architecture instruction set; that is, two or more of the cores 1102A-N may be capable of execution the same instruction set, while others may be capable of executing only a subset of that instruction set or a different instruction set.

### Exemplary Computer Architectures

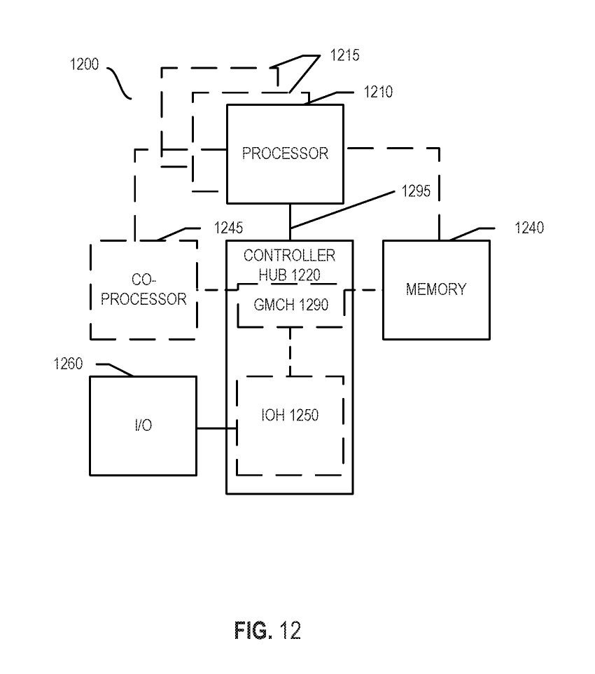

FIGS. 12-15 are block diagrams of exemplary computer architectures. Other system designs and configurations known in the arts for laptops, desktops, handheld PCs, personal digital assistants, engineering workstations, servers, network devices, network hubs, switches, embedded processors, digital signal processors (DSPs), graphics devices, video game devices, set-top boxes, micro controllers, cell phones, portable media players, hand held devices, and various other electronic devices, are also suitable. In general, a huge variety of systems or electronic devices capable of incorporating a processor and/or other execution logic as disclosed herein are generally suitable.

Referring now to FIG. 12, shown is a block diagram of a system 1200 in accordance with one embodiment of the present invention. The system 1200 may include one or more processors 1210, 1215, which are coupled to a controller hub 1220. In one embodiment the controller hub 1220 includes a graphics memory controller hub (GMCH) 1290 and an Input/Output Hub (IOH) 1250 (which may be on separate chips); the GMCH 1290 includes memory and graphics controllers to which are coupled memory 1240 and a coprocessor 1245; the IOH 1250 is couples input/output (I/O) devices 1260 to the GMCH 1290. Alternatively, one or both of the memory and graphics controllers are integrated within the processor (as described herein), the memory 1240 and the coprocessor 1245 are coupled directly to the processor 1210, and the controller hub 1220 in a single chip with the IOH 1250.

The optional nature of additional processors 1215 is denoted in FIG. 12 with broken lines. Each processor 1210, 1215 may include one or more of the processing cores described herein and may be some version of the processor 1100.

The memory 1240 may be, for example, dynamic random access memory (DRAM), phase change memory (PCM), or a combination of the two. For at least one embodiment, the controller hub 1220 communicates with the processor(s) 1210, 1215 via a multi-drop bus, such as a frontside bus (FSB), point-to-point interface such as QuickPath Interconnect (QPI), or similar connection 1295.

In one embodiment, the coprocessor 1245 is a special-purpose processor, such as, for example, a high-throughput MIC processor, a network or communication processor, compression engine, graphics processor, GPGPU, embedded processor, or the like. In one embodiment, controller hub 1220 may include an integrated graphics accelerator.

There can be a variety of differences between the physical resources 1210, 1215 in terms of a spectrum of metrics of merit including architectural, microarchitectural, thermal, power consumption characteristics, and the like.

In one embodiment, the processor 1210 executes instructions that control data processing operations of a general type. Embedded within the instructions may be coprocessor instructions. The processor 1210 recognizes these coprocessor instructions as being of a type that should be executed by the attached coprocessor 1245. Accordingly, the processor 1210 issues these coprocessor instructions (or control signals representing coprocessor instructions) on a coprocessor bus or other interconnect, to coprocessor 1245. Coprocessor(s) 1245 accept and execute the received coprocessor instructions.

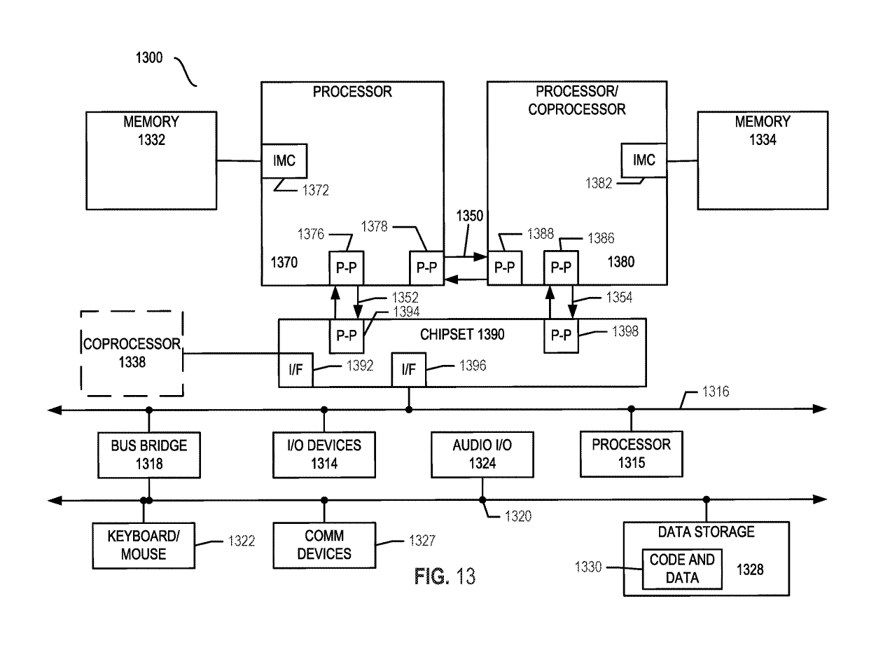

Referring now to FIG. 13, shown is a block diagram of a first more specific exemplary system 1300 in accordance with an embodiment of the present invention. As shown in FIG. 13, multiprocessor system 1300 is a point-to-point interconnect system, and includes a first processor 1370 and a second processor 1380 coupled via a point-to-point interconnect 1350. Each of processors 1370 and 1380 may be some version of the processor 1100. In one embodiment of the invention, processors 1370 and 1380 are respectively processors 1210 and 1215, while coprocessor 1338 is coprocessor 1245. In another embodiment, processors 1370 and 1380 are respectively processor 1210 coprocessor 1245.

Processors 1370 and 1380 are shown including integrated memory controller (IMC) units 1372 and 1382, respectively. Processor 1370 also includes as part of its bus controller units point-to-point (P-P) interfaces 1376 and 1378; similarly, second processor 1380 includes P-P interfaces 1386 and 1388. Processors 1370, 1380 may exchange information via a point-to-point (P-P) interface 1350 using P-P interface circuits 1378, 1388. As shown in FIG. 13, IMCs 1372 and 1382 couple the processors to respective memories, namely a memory 1332 and a memory 1334, which may be portions of main memory locally attached to the respective processors.

Processors 1370, 1380 may each exchange information with a chipset 1390 via individual P-P interfaces 1352, 1354 using point to point interface circuits 1376, 1394, 1386, 1398. Chipset 1390 may optionally exchange information with the coprocessor 1338 via a high-performance interface 1392. In one embodiment, the coprocessor 1338 is a special-purpose processor, such as, for example, a high-throughput MIC processor, a network or communication processor, compression engine, graphics processor, GPGPU, embedded processor, or the like.

A shared cache (not shown) may be included in either processor or outside of both processors, yet connected with the processors via P-P interconnect, such that either or both processors' local cache information may be stored in the shared cache if a processor is placed into a low power mode.

Chipset 1390 may be coupled to a first bus 1316 via an interface 1396. In one embodiment, first bus 1316 may be a Peripheral Component Interconnect (PCI) bus, or a bus such as a PCI Express bus or another third generation I/O interconnect bus, although the scope of the present invention is not so limited.

As shown in FIG. 13, various I/O devices 1314 may be coupled to first bus 1316, along with a bus bridge 1318 which couples first bus 1316 to a second bus 1320. In one embodiment, one or more additional processor(s) 1315, such as coprocessors, high-throughput MIC processors, GPGPU's, accelerators (such as, e.g., graphics accelerators or digital signal processing (DSP) units), field programmable gate arrays, or any other processor, are coupled to first bus 1316. In one embodiment, second bus 1320 may be a low pin count (LPC) bus. Various devices may be coupled to a second bus 1320 including, for example, a keyboard and/or mouse 1322, communication devices 1327 and a storage unit 1328 such as a disk drive or other mass storage device which may include instructions/code and data 1330, in one embodiment. Further, an audio I/O 1324 may be coupled to the second bus 1320. Note that other architectures are possible. For example, instead of the point-to-point architecture of FIG. 13, a system may implement a multi-drop bus or other such architecture.

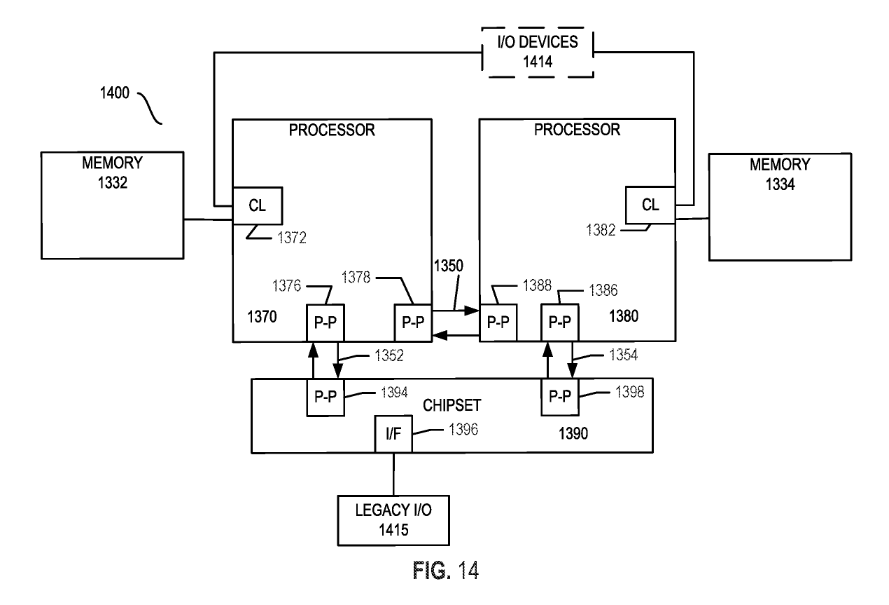

Referring now to FIG. 14, shown is a block diagram of a second more specific exemplary system 1400 in accordance with an embodiment of the present invention. Like elements in FIGS. 13 and 14 bear like reference numerals, and certain aspects of FIG. 13 have been omitted from FIG. 14 in order to avoid obscuring other aspects of FIG. 14.

FIG. 14 illustrates that the processors 1370, 1380 may include integrated memory and I/O control logic (“CL”) 1372 and 1382, respectively. Thus, the CL 1372, 1382 include integrated memory controller units and include I/O control logic. FIG. 14 illustrates that not only are the memories 1332, 1334 coupled to the CL 1372, 1382, but also that I/O devices 1414 are also coupled to the control logic 1372, 1382. Legacy I/O devices 1415 are coupled to the chipset 1390.

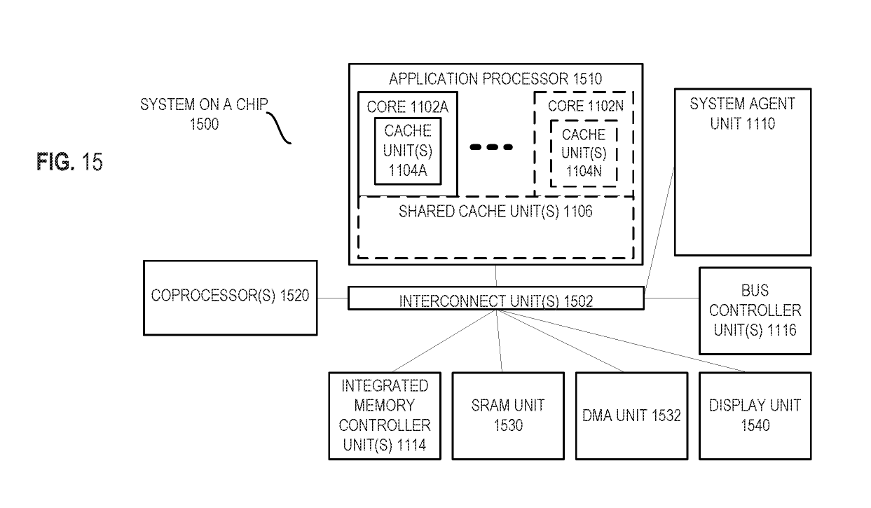

Referring now to FIG. 15, shown is a block diagram of a SoC 1500 in accordance with an embodiment of the present invention. Similar elements in FIG. 11 bear like reference numerals. Also, dashed lined boxes are optional features on more advanced SoCs. In FIG. 15, an interconnect unit(s) 1502 is coupled to: an application processor 1510 which includes a set of one or more cores 1102A-N, cache 1104A-N, and shared cache unit(s) 1106; a system agent unit 1110; a bus controller unit(s) 1116; an integrated memory controller unit(s) 1114; a set or one or more coprocessors 1520 which may include integrated graphics logic, an image processor, an audio processor, and a video processor; an static random access memory (SRAM) unit 1530; a direct memory access (DMA) unit 1532; and a display unit 1540 for coupling to one or more external displays. In one embodiment, the coprocessor(s) 1520 include a special-purpose processor, such as, for example, a network or communication processor, compression engine, GPGPU, a high-throughput MIC processor, embedded processor, or the like.

Embodiments of the mechanisms disclosed herein may be implemented in hardware, software, firmware, or a combination of such implementation approaches. Embodiments of the invention may be implemented as computer programs or program code executing on programmable systems comprising at least one processor, a storage system (including volatile and non-volatile memory and/or storage elements), at least one input device, and at least one output device.

Program code, such as code 1330 illustrated in FIG. 13, may be applied to input instructions to perform the functions described herein and generate output information. The output information may be applied to one or more output devices, in known fashion. For purposes of this application, a processing system includes any system that has a processor, such as, for example; a digital signal processor (DSP), a microcontroller, an application specific integrated circuit (ASIC), or a microprocessor.

The program code may be implemented in a high level procedural or object oriented programming language to communicate with a processing system. The program code may also be implemented in assembly or machine language, if desired. In fact, the mechanisms described herein are not limited in scope to any particular programming language. In any case, the language may be a compiled or interpreted language.

One or more aspects of at least one embodiment may be implemented by representative instructions stored on a machine-readable medium which represents various logic within the processor, which when read by a machine causes the machine to fabricate logic to perform the techniques described herein. Such representations, known as “IP cores” may be stored on a tangible, machine readable medium and supplied to various customers or manufacturing facilities to load into the fabrication machines that actually make the logic or processor.

Such machine-readable storage media may include, without limitation, non-transitory, tangible arrangements of articles manufactured or formed by a machine or device, including storage media such as hard disks, any other type of disk including floppy disks, optical disks, compact disk read-only memories (CD-ROMs), compact disk rewritable's (CD-RWs), and magneto-optical disks, semiconductor devices such as read-only memories (ROMs), random access memories (RAMS) such as dynamic random access memories (DRAMs), static random access memories (SRAMs), erasable programmable read-only memories (EPROMs), flash memories, electrically erasable programmable read-only memories (EEPROMs), phase change memory (PCM), magnetic or optical cards, or any other type of media suitable for storing electronic instructions.

Accordingly, embodiments of the invention also include non-transitory, tangible machine-readable media containing instructions or containing design data, such as Hardware Description Language (HDL), which defines structures, circuits, apparatuses, processors and/or system features described herein. Such embodiments may also be referred to as program products.

### Emulation (Including Binary Translation, Code Morphing, Etc.)

In some cases, an instruction converter may be used to convert an instruction from a source instruction set to a target instruction set. For example, the instruction converter may translate (e.g., using static binary translation, dynamic binary translation including dynamic compilation), morph, emulate, or otherwise convert an instruction to one or more other instructions to be processed by the core. The instruction converter may be implemented in software, hardware, firmware, or a combination thereof. The instruction converter may be on processor, off processor, or part on and part off processor.

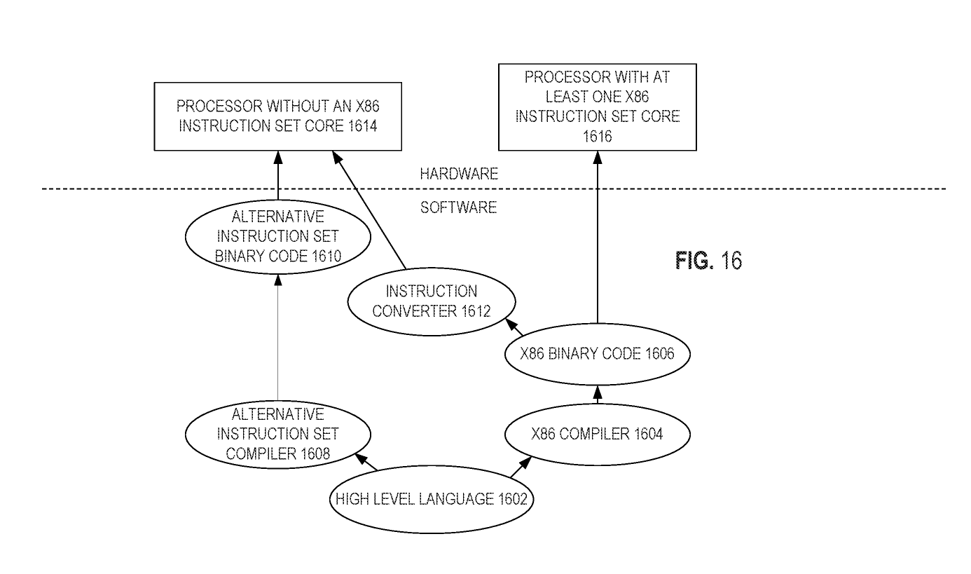

FIG. 16 is a block diagram contrasting the use of a software instruction converter to convert binary instructions in a source instruction set to binary instructions in a target instruction set according to embodiments of the invention. In the illustrated embodiment, the instruction converter is a software instruction converter, although alternatively the instruction converter may be implemented in software, firmware, hardware, or various combinations thereof. FIG. 16 shows a program in a high level language 1602 may be compiled using an x86 compiler 1604 to generate x86 binary code 1606 that may be natively executed by a processor with at least one x86 instruction set core 1616. The processor with at least one x86 instruction set core 1616 represents any processor that can perform substantially the same functions as an Intel processor with at least one x86 instruction set core by compatibly executing or otherwise processing (1) a substantial portion of the instruction set of the Intel x86 instruction set core or (2) object code versions of applications or other software targeted to run on an Intel processor with at least one x86 instruction set core, in order to achieve substantially the same result as an Intel processor with at least one x86 instruction set core. The x86 compiler 1604 represents a compiler that is operable to generate x86 binary code 1606 (e.g., object code) that can, with or without additional linkage processing, be executed on the processor with at least one x86 instruction set core 1616. Similarly, FIG. 16 shows the program in the high level language 1602 may be compiled using an alternative instruction set compiler 1608 to generate alternative instruction set binary code 1610 that may be natively executed by a processor without at least one x86 instruction set core 1614 (e.g., a processor with cores that execute the MIPS instruction set of MIPS Technologies of Sunnyvale, Calif. and/or that execute the ARM instruction set of ARM Holdings of Sunnyvale, Calif.). The instruction converter 1612 is used to convert the x86 binary code 1606 into code that may be natively executed by the processor without an x86 instruction set core 1614. This converted code is not likely to be the same as the alternative instruction set binary code 1610 because an instruction converter capable of this is difficult to make; however, the converted code will accomplish the general operation and be made up of instructions from the alternative instruction set. Thus, the instruction converter 1612 represents software, firmware, hardware, or a combination thereof that, through emulation, simulation or any other process, allows a processor or other electronic device that does not have an x86 instruction set processor or core to execute the x86 binary code 1606.

What is claimed is:

1. An apparatus comprising:
address translation circuitry to translation a virtual address to a physical address and to provide a first protection domain;
at least one protection range register, the at least one protection range register to store a range of virtual addresses to protect as part of a protection domain;
comparison circuitry to compare the virtual address to the range of virtual addresses of the at least one protection range register and to output a second protection domain upon a match in of the virtual address and the range of virtual addresses of the at least one protection register; and
a selector circuit to select between the first and second protection domain.

2. The apparatus of claim 1, wherein the range of addresses is set by a base virtual address and a limit virtual address.

3. The apparatus of claim 1, wherein the selector circuit to select the first protection domain when there is no output of the second protection domain.

4. The apparatus of claim 1, wherein the selector circuit to select the second protection domain when there is an output of the second protection domain.

5. The apparatus of claim 1, wherein the at least one protection range register is a register pair and a first register of the register pair to store a base virtual address and a second register of the register pair to store a limit virtual address.

6. The apparatus of claim 5, wherein the first register of the pair of registers to store one of a valid bit and a protection domain.

7. The apparatus of claim 1, wherein the at least one protection range register to store a valid bit and a protection domain.

8. The apparatus of claim 1, wherein the first and second protection domains are indicated by 4-bit values.

9. The apparatus of claim 1, wherein address translation circuitry is a part of a translation lookaside buffer.

10. The apparatus of claim 9, wherein the first protection domain is indicated by a plurality of bits in a page table entry.

11. A method comprising:
receiving a virtual address at address translation circuitry to translation the virtual address to a physical address and to provide a first protection domain;
comparing the virtual address to a range of virtual addresses of at least one protection range register and to output a second protection domain upon a match in of the virtual address and the range of virtual addresses of the at least one protection register; and
selecting between the first and second protection domain.

12. The method of claim 11, wherein the range of addresses is set by a base virtual address and a limit virtual address.

13. The method of claim 11, wherein the first protection domain is selected when there is no output of the second protection domain.

14. The method of claim 11, wherein the second protection domain is selected when there is an output of the second protection domain.

15. The method of claim 11, wherein the at least one protection range register is a register pair and a first register of the register pair to store a base virtual address and a second register of the register pair to store a limit virtual address.

16. The method of claim 15, wherein the first register of the pair of registers to store one of a valid bit and a protection domain.

17. The method of claim 11, wherein the at least one protection range register to store a valid bit and a protection domain.

18. The method of claim 11, wherein the first and second protection domains are indicated by 4-bit values.

19. The method of claim 11, wherein address translation circuitry is a part of a translation lookaside buffer.

20. The method of claim 19, wherein the first protection domain is indicated by a plurality of bits in a page table entry.
